(19) United States
(12) Patent Application Publication
(10) Pub. No.: US 2012/0227062 A1
(43) Pub. Date: Sep. 6, 2012

(54) OPTICAL PICK-UP HEAD MODULE

(75) Inventors: Cheng-Chung Hsu, Hsinchu (TW); Chia-Yuan Lin, Hsinchu (TW); Chun-Lung Ho, Hsinchu (TW)

(73) Assignee: PHILIPS & LITE-ON DIGITAL SOLUTIONS CORPORATION, TAIPEI CITY (TW)

(21) Appl. No.: 13/075,184

(22) Filed: Mar. 30, 2011

(30) Foreign Application Priority Data
Mar. 1, 2011 (CN) 201110048696.1

(51) Int. Cl. G11B 7/085

(52) U.S. Cl. 720/663; G9B/7.042

(57) ABSTRACT

An optical pick-up head module includes a base, an optical pick-up head adjusting mechanism, two guiding rods, a spring and an optical pick-up head slidably disposed on the guiding rods. The optical pick-up head adjusting mechanism includes a protrusion, a pillar and an adjusting element. The protrusion connected to the base has a sliding slot. The pillar having first and second flat surfaces is slidably disposed in the sliding slot. The first flat surface contacts an inner wall of the sliding slot. The adjusting element is screwed on the base. The spring disposed on the base pushes the pillar to contact the adjusting element by the second flat surface. When the adjusting element is rotated, the adjusting element pushes the pillar toward the base.

### CROSS-REFERENCE TO RELATED APPLICATION

This application claims the priority benefit of China application serial no.201110048696.1, filed Mar. 1, 2011. The entirety of the above-mentioned patent application is hereby incorporated by reference herein and made a part of this specification.

### BACKGROUND OF THE INVENTION

1. Field of the Invention

The invention relates to an optical device, and more particularly to an optical pick-up head module.

2. Description of Related Art

Computer technology has increasingly developed and the data processed by computer requiring a larger storage space for storing data. Since an optical disk has the advantages of reasonable price, portability, large storage capacity, easy data storage, long term storage, secure storage of data, and so on, the optical disk has gradually replaced the conventional magnetic storage medium and has become an indispensable optical storage medium in modern life. With the widespread use of the optical disk, the optical disk drive for reading the data in the optical disk has also become a necessary electronic product in daily life.

An optical disk drive has an optical pick-up head, wherein the optical pick-up head emits a laser beam to the optical disk to read the data in the optical disk. Common optical disk drives has an adjusting mechanism to adjust a slope of the optical pick-up head. The adjusting mechanism causes the laser beam to be perpendicular to the optical disk surface to increase the precision and effectiveness of reading/writing the data.

As optical disk drives trend towards light, thin, short, and small models, the operating space for the adjusting mechanism becomes limited. Thus, how to simplify or improve structure design to reduce size and production cost without affecting the function of the adjusting mechanism has become an important subject.

### SUMMARY OF THE INVENTION

The invention provides an optical pick-up head module having the advantages of saving space and lowering production costs.

The invention provides an optical pick-up head module for an optical disk drive. The optical pick-up head module includes a base, at least one optical pick-up head adjusting mechanism, two guiding rods, and an optical pick-up head. Each guiding rod has two opposite ends, and two ends of the optical pick-up head are slidably disposed on the two guiding rods, respectively. The optical pick-up head adjusting mechanism includes a spring, a protrusion, a pillar, and an adjusting element. The protrusion is connected to the base and has a sliding slot. The pillar has a first flat surface and a second flat surface, and is slidably disposed in the sliding slot, wherein the first flat surface contacts an inner wall of the sliding slot. The adjusting element is screwed on the base, and the position of the pillar is limited between the adjusting element and the base. The spring is disposed between the base and the pillar, and pushes the pillar towards the adjusting element, so the second flat surface contacts the adjusting element. When the adjusting element is rotated, the adjusting element resists the elastic force of the spring and pushes the pillar towards the base along the sliding slot, so as to adjust a relative height and angle between the optical pick-up head and the base.

In an embodiment of the invention, the pillar has a third flat surface, and the third flat surface contacts the other inner wall of the sliding slot.

In an embodiment of the invention, the second flat surface is perpendicular to the third flat surface.

In an embodiment of the invention, the first flat surface is perpendicular to the second flat surface.

In an embodiment of the invention, the protrusion is integrally formed with the base.

In an embodiment of the invention, the optical disk drive has a case, and a surface of the base has a concave. There is a first distance between a bottom surface of the concave and the case, and a second distance between the surface and the case, wherein the first distance is greater than the second distance, and the adjusting element is screwed in the concave.

In an embodiment of the invention, the spring is a tower spring.

In an embodiment of the invention, the base has an opening, and the spring is fixed in the opening.

Based on the above, the pillar of the invention has a first flat surface and a second flat surface, and is a non-circular pillar structure. The first flat surface and the second flat surface can be formed by cutting a portion material of a circular pillar structure, so as to achieve the goal of reducing the outer diameter of the pillar. Since the pillar has a smaller outer diameter, when a movement range of an axis of the pillar is constant, a movement range of the adjusting element used to push the pillar will be closer to the base and farther from the case of the optical disk drive, and interference between the adjusting element and the case during operation in the optical disk drive is avoided, so as to have a light and thin optical disk drive case.

In order to make the aforementioned and other features and advantages of the invention more comprehensible, embodiments accompanying figures are described in detail below.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a three-dimensional view of an optical pick-up head module according to an embodiment of the invention.

FIG. 2 is a partial structural three-dimensional view of the optical pick-up head module of FIG. 1.

FIG. 3 is a partial cross-sectional view of an optical pick-up head adjusting mechanism of FIG. 1.

FIG. 4 is a partial cross-sectional view of an optical pick-up head adjusting mechanism of FIG. 1.

### DESCRIPTION OF EMBODIMENTS

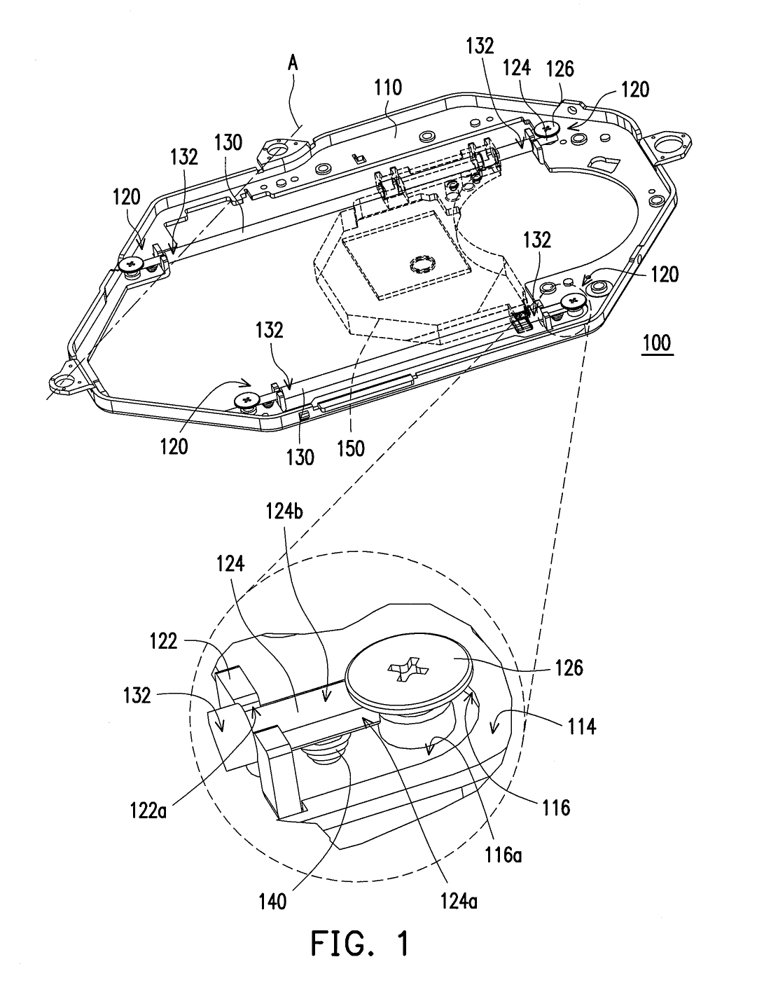

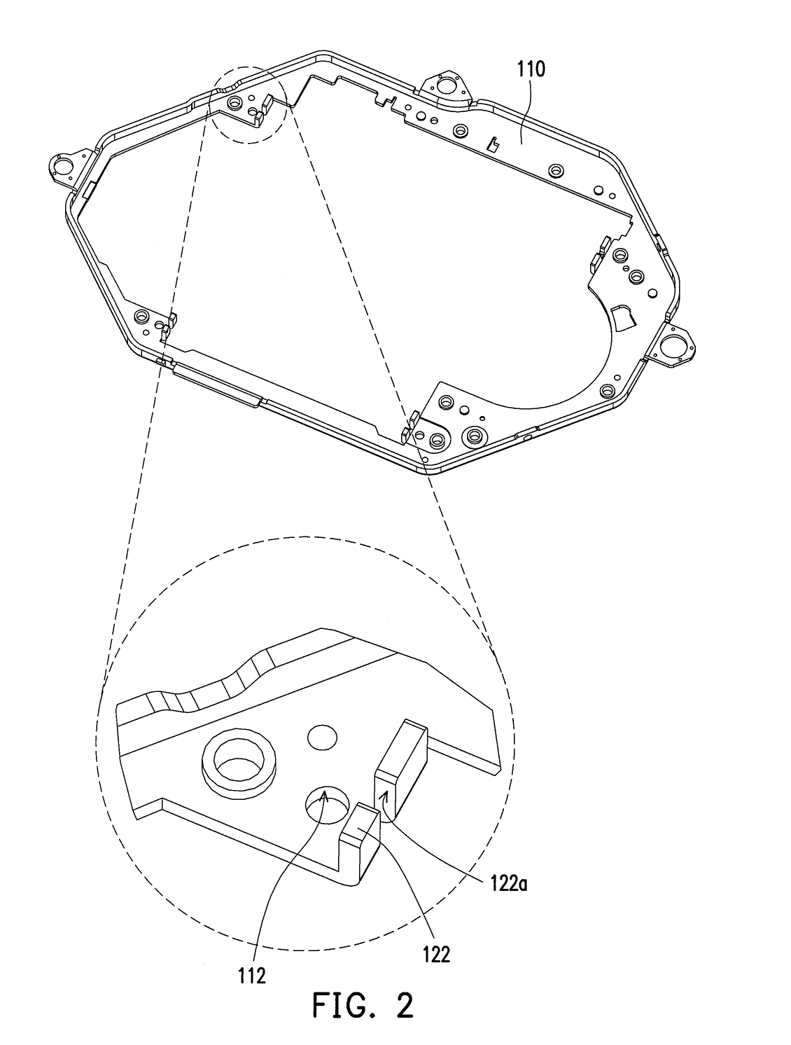

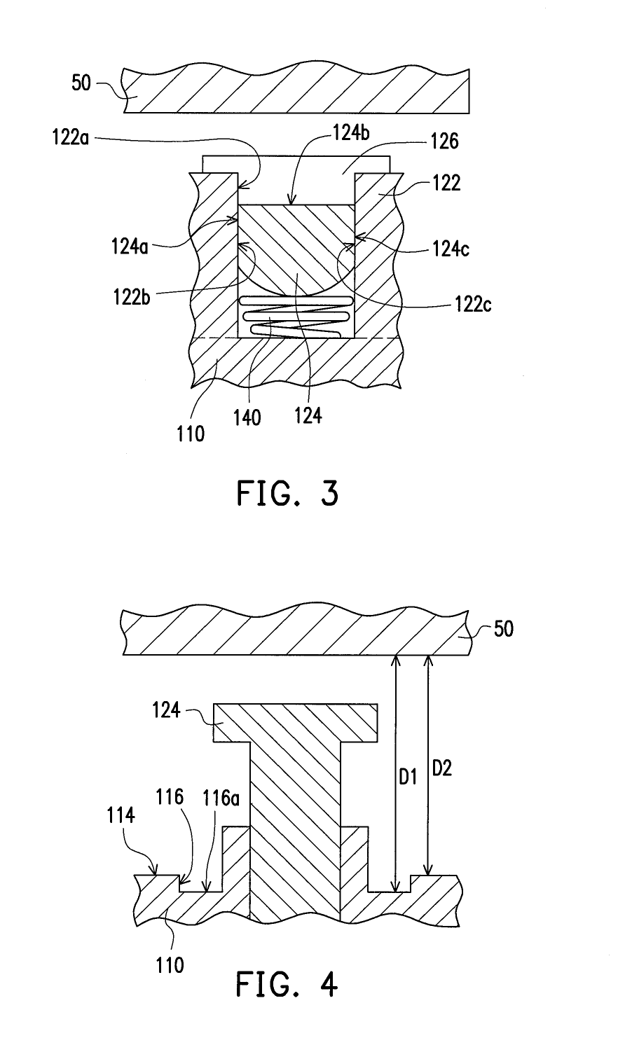

FIG. 1 is a three-dimensional view of an optical pick-up head module according to an embodiment of the invention. FIG. 2 is a partial structural three-dimensional view of the optical pick-up head module of FIG. 1. FIG. 3 is a partial cross-sectional view of an optical pick-up head adjusting mechanism of FIG. 1. For better illustration, an optical pick-up head 150 of FIG. 1 is perspective illustrated.

Referring from FIGS. 1 to 3, the optical pick-up head module 100 of the embodiment is suitable for a thin optical disk drive (not shown) and includes a base 110, at least one optical pick-up head adjusting mechanism 120 (shown as four), two parallel guiding rods 130, at least a spring 140 (shown as three), and the optical pick-up head 150. Two ends of the optical pick-up head 150 are slidably disposed on the two guiding rods 130, respectively, so the optical pick-up head 150 is suitable to move along the guiding rods 130 and read the optical disk (not shown).

The optical pick-up head adjusting mechanism 120 includes a protrusion 122, a pillar 124, and an adjusting element 126. The protrusion 122 is connected to the base 110 and has a sliding slot 122a. The pillar 124 can move in the sliding slot 122a, and has a first flat surface 124a, a second flat surface 124b, and a third flat surface 124c. The second flat surface 124b is perpendicular to the first flat surface 124a and the third flat surface 124c. The first flat surface 124a and the third flat surface 124c respectively contacts an inner wall 122b and an inner wall 122c of the sliding slot 122a. The adjusting element 126 is a screw, screwed onto the base 110. A position of the pillar 124 is limited between the adjusting element 126 and the base 110, and the spring 140 is disposed between the base 110 and the pillar 124. The spring 140 pushes the pillar 124 towards the adjusting element 126, so the second flat surface 124b contacts the adjusting element 126.

The guiding rods 130 are circular pillar, and each guiding rod 130 has two ends 132 opposite to each other. The pillar 124 can be formed by being integrally extended from the end 132 and then cut the portion of the circular pillar, or the pillar 124 is fixed on the end 132 by an additional attachment method, such as screwing, soldering, or adhering.

In the embodiment, the quantity of the spring 140 is three and respectively supports three of the pillars 124. The pillar 124 and the adjusting element 126 in the top right of FIG. 1 serves as a reference point and does not move when adjusting, and thus does not need a corresponding spring 140. The user can rotate the adjusting element 126, so the adjusting element 126 resists an elastic force of the spring 140 and pushes the pillar 124 towards the base 110 along the sliding slot 122a. When the pillar 124 moves, the guiding rod 130 slopes and a relative angle between the optical pick-up head 150 and the base 110 is adjusted.

In the configuration method above, the pillar 124 has the first flat surface 124a, the second flat surface 124b, and the third flat surface 124c, and is a non-circular pillar structure. The first flat surface 124a, the second flat surface 124b, and the third flat surface 124c can be formed by cutting a portion material of a circular pillar structure, so as to achieve the goal of reducing the outer diameter of the pillar 124. Since the pillar 124 has a smaller outer diameter (compared with the circular pillar), when a movement range of an axis of the pillar 124 is constant, a movement range of the adjusting element 126 used to push the pillar 124 will be closer to the base 110 and farther from the case of the optical disk drive, and interference between the adjusting element 126 and the case 50 (shown in FIG. 3) during operation in the optical disk drive is avoided, so as to have a light and thin optical disk drive case 50.

In the embodiment, each protrusion 122 is, for example, integrally formed and connected with the base 110. Consequently, the number of components can be reduced, and the fabrication process is simplified to reduce overall production cost. In addition, each spring 140 of the embodiment can be a tower spring having different end diameters. The base 110 has an opening 112 (referenced in FIG. 2) for fixing the spring 140. The end of the spring 140 with a greater diameter resists the pillar 124, and the end of the spring 140 with a smaller diameter is fixed in the opening 112. In addition, with the design of the first flat surface 124a and the third flat surface 124c which allows the pillar 124 to have a smaller outer diameter and the dimensions of the sliding slot 122a are also reduced. The dimensions of the protrusion 122 is increased and also improves the structure and strength of the protrusion 122.

FIG. 4 is a partial cross-sectional view of an optical pick-up head adjusting mechanism of FIG. 1. Referring to FIG. 1 and FIG. 4, a surface 114 of the base 110 of the embodiment has a concave 116. There is a first distance Dl between a bottom surface 116a of the concave 116 and the case 50, and a second distance D2 between the surface 114 and the case 50, wherein the first distance D1 is greater than the second distance D2, and the adjusting element 126 is screwed in the concave 116. With the design of the concave 116, the level of adjustment towards the tower spring 140 between the pillar 124 and the bottom surface 116a of the concave 116 can be increased.

More specifically, the optical pick-up head module 100 is, for example, designed to be sloped along an axis A in FIG. 1 so that the optical disk can be placed in the optical disk drive. Therefore, the adjusting element 126 on the bottom right corner of FIG. 1 will have larger positional displacement because the optical pick-up head module 100 slopes along the axis A. Consequently, the concave 116 can be disposed in the bottom right corner to avoid interference between the adjusting element 126 and the case 50.

To sum up, the pillar of the invention has a first flat surface, a second flat surface, and a third flat surface, and is a non-circular pillar structure. The first flat surface, the second flat surface, and the third flat surface can be formed by cutting a portion material of a circular pillar structure so as to reduce the outer diameter of the pillar. Since the pillar has a smaller outer diameter, when a movement range of an axis of the pillar is constant, a movement range of the adjusting element used to push the pillar will be closer to the base and farther from the case of the optical disk drive. And interference between the adjusting element and the case during operation in the optical disk drive is avoided so as to have a light and thin optical disk drive case. In addition, the protrusion coupled to the pillar can be integrally formed and connected with the base. Consequently, the number of components can be reduced, and the fabrication process is simplified to reduce overall production cost. Moreover, with the design of the first flat surface and the third flat surface, the dimensions of the sliding slot are also reduced. Hence, the dimensions of the protrusion can be increased to improve the structure and strength of the protrusion.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. An optical pick-up head module for an optical drive, the optical pick-up head module comprising:
a base;
two guiding rods, each of the guiding rods having two opposite ends;
an optical pick-up head, wherein two ends of the optical pick-up head are slidably disposed on the two guiding rods, respectively; and
at least one optical pick-up head adjusting mechanism, comprising:
a protrusion connected to the base and having a sliding slot;
a pillar connected to the end of the guiding rod, having a first flat surface and a second flat surface, and being slidably disposed in the sliding slot, wherein the first flat surface contacts an inner wall of the sliding slot;
an adjusting element screwed on the base, wherein a position of the pillar is limited between the adjusting element and the base; and
a spring disposed between the base and the pillar, wherein the spring pushes the pillar towards the adjusting element so the second flat surface contacts the adjusting element;
wherein when the adjusting element is rotated, the adjusting element resists an elastic force of the spring and pushes the pillar towards the base along the sliding slot, so as to adjust a relative angle between the optical pick-up head and the base.

2. The optical pick-up head module as claimed in claim 1, wherein the pillar has a third flat surface, the third flat surface contacting the other inner wall of the sliding slot.

3. The optical pick-up head module as claimed in claim 2, wherein the second flat surface is perpendicular to the third flat surface.

4. The optical pick-up head module as claimed in claim 1, wherein the first flat surface is perpendicular to the second flat surface.

5. The optical pick-up head module as claimed in claim 1, wherein the protrusion is integrally formed with the base.

6. The optical pick-up head module as claimed in claim 1, wherein the optical disk drive has a case, and a surface of the base has a concave, a first distance being between a bottom surface of the concave and the case, a second distance being between the surface and the case, wherein the first distance is greater than the second distance, and the adjusting element is screwed in the concave.

7. The optical pick-up head module as claimed in claim 1, wherein the spring is a tower spring.

8. The optical pick-up head module as claimed in claim 1, wherein the pillar is integrally formed with the guiding rod.

9. The optical pick-up head module as claimed in claim 1, wherein the pillar is additionally fixed on the end, such as by screwing, soldering, or adhering.

10. The optical pick-up head module as claimed in claim 1, wherein the base has an opening, and the spring is fixed in the opening.
